(19) United States
(12) Patent Application Publication
(10) Pub. No.: US 2024/0077993 A1
(43) Pub. Date: Mar. 7, 2024

(54) INFORMATION PROCESSING METHOD, APPARATUS, ELECTRONIC DEVICE, AND STORAGE MEDIUM

(71) Applicant: Beijing Zitiao Network Technology Co., Ltd., Beijing (CN)

(72) Inventors: Yuanye WU, Beijing (CN); Ningsha Huang, Beijing (CN); Yifei Xue, Beijing (CN); Jian Sun, Beijing (CN)

(21) Appl. No.: 18/506,689

(22) Filed: Nov. 10, 2023

Related U.S. Application Data
(63) Continuation of application No. PCT/CN22/92429, filed on May 12, 2022.

(30) Foreign Application Priority Data
May 12, 2021 (CN) 202110519328.4

(51) Int. Cl. G06F 3/0484; G06F 9/451

(52) U.S. Cl. CPC G06F 3/0484; G06F 9/451; H04L 51/04

(57) ABSTRACT

There is provided an information processing method, apparatus, electronic device, and storage medium for information processing. The information processing method includes: receiving first task information; and displaying second task information in a task interface after a first preset control in the first task information is triggered, where participants of the first task information and the second task information are different, and display regions for the participants are different from display regions for executors or creators of corresponding task information. By enabling a user to follow or participate in the first task information in response to an operation on the first preset control in the first task information, and displaying the second task information including following or participation information in the task interface, corresponding users can be informed about the progress of corresponding tasks in time and can receive notifications of the progress of the corresponding tasks in time.

### CROSS-REFERENCE TO RELATED APPLICATION(S)

This application is a Continuation Application of International Patent Application No. PCT/CN2022/092429, filed May 12, 2022, which claims priority to Chinese Application No. 202110519328.4 filed May 12, 2021, the disclosures of which are incorporated herein by reference in their entities.

### FIELD

The present disclosure relates to the field of information technology, and in particular to information processing method, apparatus, electronic device and storage medium.

### BACKGROUND

Since managers have to process various tasks in daily work, they cannot constantly follow up completion of each task by each employee, whereas the employees cannot report each task to the managers in detail. In view of this, an instant messaging tool or document capable of, e.g., task creation and management is desired to have a function that informs the managers or relevant colleagues about the progress of relevant tasks without increasing burden on all parties.

### SUMMARY

In order to solve the existing problems, the present disclosure provides a method, an apparatus, an electronic device, and a storage medium for information processing.

The present disclosure employs the following technical solutions.

An embodiment of the present disclosure provides an information processing method. The information processing method comprises: receiving first task information; and displaying second task information in a task interface after a first preset control in the first task information is triggered, where participants of the first task information and the second task information are different, and display regions for the participants are different from display regions for executors or creators of corresponding task information.

Another embodiment of the present disclosure provides an information processing method. The information processing method comprises: receiving first task information; modifying participant information of the first task information after a first preset control in the first task information is triggered, where the first task information includes a participant information set and an executor information set; and when information of a preset field of the second task information is changed, sending a first notification message to a participant of the second task information according to the participant information set.

Another embodiment of the present disclosure provides an information processing apparatus. The information processing apparatus comprises: an information reception module configured to receive first task information; and an information processing module configured to display second task information in a task interface after a first preset control in the first task information is triggered, where participants of the first task information and the second task information are different, and display regions for the participants are different from display regions for executors or creators of corresponding task information.

Another embodiment of the present disclosure provides an information processing method. The information processing method comprises: in response to a preset operation by the executor or the creator of the first task information for adding a participant for the first task information, displaying second task information in a task interface, where participants of the first task information and the second task information are different.

Another embodiment of the present disclosure provides an information processing method. The information processing method comprises: after a first preset control in first task information in a document interface is triggered, displaying second task information in the document interface, where participants of the first task information and the second task information are different, and the participants of the first task information and the second task information are different from executors or creators of corresponding task information.

In some embodiments, the present disclosure provides an electronic device. The electronic device comprises: at least one memory and at least one processor, where the memory is configured to store program codes, and the processor is configured to invoke program codes stored in the at least one memory to execute the information processing method described above.

In some embodiments, the present disclosure provides a storage medium. The storage medium is configured to store program codes, where the program codes are configured to execute the information processing method described above.

According to the embodiments of the present disclosure, by enabling a user to follow or participate in the first task information in response to an operation on the first preset control in the first task information, and displaying the second task information including following or participation information in the task interface, corresponding users can be informed about the progress of corresponding tasks in time and can receive notifications of the progress of the corresponding tasks in time.

### BRIEF DESCRIPTION OF THE DRAWINGS

What is described above and other features, advantages, and aspects of each embodiment of the present disclosure will become more apparent in combination with the accompanying drawings and with reference to the following detailed description. Throughout the accompanying drawings, the same or similar reference numerals denote the same or similar elements. It should be understood that the accompanying drawings are schematic, and components and elements are not necessarily drawn to scale.

FIG. 1 is a flow chart of an information processing method according to some embodiments of the present disclosure.

FIG. 2 is a schematic diagram of a session interface according to some embodiments of the present disclosure.

FIG. 3 is a schematic diagram of task detail information according to some embodiments of the present disclosure.

FIG. 4 is a schematic diagram of task detail information according to some embodiments of the present disclosure.

FIG. 5 is a schematic diagram of a session interface according to some embodiments of the present disclosure.

FIG. 6 is a flow chart of an information processing method according to some embodiments of the present disclosure.

FIG. 7 shows a schematic diagram of some modules of an information processing apparatus according to some embodiments of the present disclosure.

FIG. 8 is a schematic structural diagram of an electronic device according to an embodiment of the present disclosure.

### DETAILED DESCRIPTION OF EMBODIMENTS

The embodiments of the present disclosure will be described in more detail below with reference to the accompanying drawings. Although some embodiments of the present disclosure are shown in the accompanying drawings, it should be understood that the present disclosure can be implemented in various forms and should not be limited to the embodiments described herein. On the contrary, these embodiments are provided for a more thorough and complete understanding of the present disclosure. It should be understood that the accompanying drawings and embodiments of the present disclosure are merely for illustrative purposes and are not intended to limit the scope of protection of the present disclosure.

It should be understood that the steps described in the apparatus embodiment of the present disclosure can be executed in different orders and/or in parallel. In addition, the apparatus embodiment can include additional steps and/or steps shown for execution omitted. The scope of the present disclosure is not limited in this regard.

The terms “comprise”, “include” and variations thereof used herein are open-ended, i.e. “comprising, but not limited to” and “including, but not limited to”. The terms “on the basis of” and “based on” refer to “at least partially on the basis of” and “at least partially based on”. The term “an embodiment” means “at least one embodiment”; the term “another embodiment” means “at least one another embodiment”; and the term “some embodiments” means “at least some embodiments”. The term “in response to” and related terms mean that one signal or event is affected by another signal or event to some extent, but is not necessarily affected completely or directly. If an event x occurs “in response to” an event y, x can directly or indirectly respond to y. For example, the appearance of y can ultimately lead to the appearance of x, but there may be other intermediate events and/or conditions. In other situations, y may not necessarily lead to the occurrence of x, and even if y has not yet occurred, x may still occur. In addition, the term “in response to” can further mean “at least partially in response to”. The term “determine” encompasses a wide range of actions, which can include calculus, computation, processing, deduction, research, search (such as search in tables, databases, or other data structures), ascertain, and similar actions, and can further include receiving (such as receiving information), accessing (such as accessing data in a memory), and similar actions, as well as parsing, selecting, picking, establishing, and similar actions. Related definitions of other terms will be provided in the following description. Related definitions of other terms will be provided in the following description.

It should be noted that the concepts such as “first” and “second” mentioned in the present disclosure are merely intended to distinguish different apparatuses, modules, or units, and are not intended to define the order or interdependence of the functions executed by these apparatuses, modules, or units.

It should be noted that the modification of “a”, “an” or “multiple” mentioned in the present disclosure is illustrative rather than limitative, and should be understood by those skilled in the art as “one or more” unless explicitly stated otherwise in the context.

For the purposes of the present disclosure, the phrase “A and/or B” means (A), (B), or (A and B).

The names of messages or information exchanged between multiple apparatuses in the embodiments of the present disclosure are merely illustrative, and are not intended to limit the scope of these messages or information.

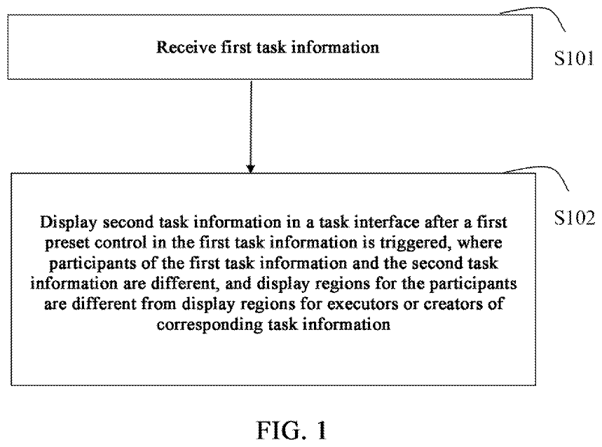

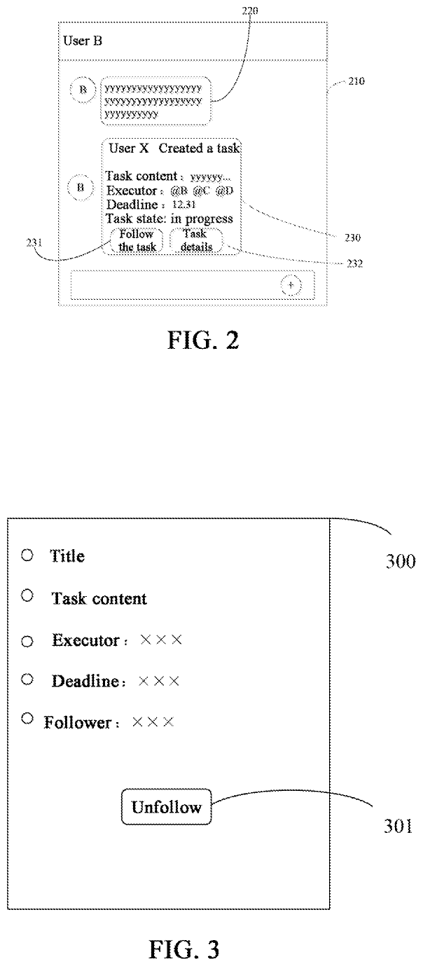

FIG. 1 provides a flow chart of an information processing method according to an embodiment of the present disclosure. The information processing method of the present disclosure may include Step S101: receive first task information. In some embodiments, the first task information may be received in any suitable tool capable of task tracking. For example, the first task information may be received in an instant messaging client or a document tool. In some embodiments, the instant messaging client may be a client of any suitable instant messaging application, and a user may perform instant messaging with the client. In some embodiments, a to-do list or task setting may be performed in the instant messaging client, such that the corresponding instant messaging application may be applied to an application scene such as work or game. In some embodiments, the first task information may be received at a session interface of the instant messaging client. In some embodiments, the first task information may be forwarded at the session interface of the instant messaging client. In some embodiments, as shown in FIG. 2, a certain session content 220 and first task information 230 sent by user B and received by a certain user of an instant messaging client are displayed in a session interface 210 between the certain user and user B.

In some embodiments, the method of the present disclosure may further include Step S102: display second task information in a task interface after a first preset control in the first task information is triggered, where participants of the first task information and the second task information are different, and display regions for the participants are different from display regions for executors or creators of corresponding task information. In some embodiments, displaying second task information in a task interface (e.g., of an instant messaging client) after a first preset control in the first task information is triggered may be displaying the task interface of the instant messaging client based on a viewing operation of the user, or may be automatically jumping to a corresponding task interface after the first preset control is triggered. In some embodiments, the first preset control may be displayed in the first task information in a floating window or embedded manner. FIG. 2 shows that a first preset control 231 is displayed in the first task information 230 in an embedded manner, but this is only exemplary, and the first preset control 231 may further be displayed in the first task information 230 in other suitable manners. In some embodiments, other suitable contents may be displayed in the first preset control 231 instead of “Follow the task”, because the text displayed in the first preset control 231 is also exemplary.

In some embodiments, the second task information may be displayed in the task interface of the instant messaging client, for example, in the “Followed by me” task interface, after the first preset control in the first task information is triggered. In some embodiments, after the first preset control in the first task information is triggered, a preset field (e.g. “Participant”) in the first task information 230 is caused to be changed, and thus the first task information 230 becomes the changed second task information. Participants of the first task information 230 and the second task information are different because the preset field (e.g. “Participant”) in the first task information 230 is changed in this case. In some embodiments, the participant (or “Follower”) may not be the executor or the creator of corresponding task information, but rather a result of following from a third party. Certainly, the executor or the creator of the corresponding task information may also become the participant of the task information.

According to the embodiment of the present disclosure, the second task information can be displayed in the task interface after an operation on the first preset control in the first task information is received. Participants of the first task information and the second task information are different, and the display regions for the participants are different from display regions for executors or creators of corresponding task information, such that related colleagues or personnel can follow a certain task by means of a preset operation after the task is created. After the user follows the task, the progress of the task can be viewed by the user at any time, and related notification information can be sent to the user who follows the task to the task in time when some situation changes (e.g. task completion, executor change, deadline change, etc.) occur in the task. For example, when a certain content of the task information is changed, the instant messaging client can send related notification information to the user who follows the task in time such that the user can be informed about related situations of the task in time. In addition, the display region for the participant is distinguished from the display region for the executor or the creator such that related notification information can be sent to the follower in a more targeted manner, because a person who follows the progress of the task is usually a superior or a leader of the executor or the creator, not the executor of the task. The display region for the participant is distinguished from the display region for the executor or the creator, which is particularly suitable for a scene in which the superior and the leader obtain the notification message of the progress of the corresponding task in time.

In some embodiments, as described above, receiving the first task information may include receiving the first task information at an instant messaging client, and displaying the second task information in the task interface may include displaying the second task information in the task interface of the instant messaging client. Thus, task tracking and setting can be performed at the instant messaging client, extending the functionality of the instant messaging client and improving user experience.

In some embodiments, when a certain user is added as a follower as a task is created, or the certain user is deleted as an identity of the follower, or a title, a content, a deadline, or a state of the task is changed (e.g. the state is updated as task completion), a system may send a corresponding notification message to the user, such that the user may be informed about related situations of the task in time. In some embodiments, related situation changes of the task described above may also be reflected in a history record node of the task. In some embodiments, information about the history record node may be displayed at a preset position (e.g. bottom, etc.) in task detail information. In some embodiments, when a follower of a certain task is also a creator and/or executor of the task, the notification message may be filtered according to the priorities of the creator, the executor, and the follower. For example, if an executor of a task is also a follower, the system sends a notification message to the user as the role of an executor, and no longer sends a corresponding task notification to the user as the role of a follower. Thus, the efficient and concise notification message is facilitated, and the redundant notification message is avoided.

In some embodiments, when information of a preset field of the second task information is changed, a corresponding notification message is sent to the participant of the second task information, and the corresponding notification message is not sent to the executor of the second task information. In some embodiments, the information of the preset field may include, but is not limited to, a title, a content, a deadline, or a state of the task. Thus, the notification message may be sent to a group of participants in a targeted manner, which is particularly suitable for a scene in which a superior and a leader obtain the notification message of the progress of the corresponding task in time. In addition, a notification is further prevented from being sent to the executor who executes the corresponding task, because the executor is usually a specific execution person who actively changes the information of the preset field and does not need additional notification.

In some embodiments, when the information of the preset field of the second task information changes, a third notification message is sent to the executor of the second task information, and the third notification message is not sent to the participant (e.g., the follower) of the second task information. In some embodiments, the information of the preset fields may include, but is not limited to, a title, a content, a deadline or a state of the task, or an executor, or a participant. In this way, notification messages may be sent to a group of executors in a targeted manner to let the executors know the progress of the task and other relevant information in time. For example, after a new person follows the task, a notification may be sent to inform the executor that a new person has followed the task. In addition, participants may not care whether others follow the task, so no additional notification is needed. In some embodiments, when the information of the preset field of the second task information changes, a third notification message is sent to the executor of the second task information, and a fourth notification message is sent to the participant of the second task information. The third notification information and the fourth notification information have different specific contents or styles. For example, when a previous stage of a task is completed, a notification message similar to “The previous stage of the task is completed, please execute the next stage” may be sent to the executor, while only a notification message similar to “The previous stage of the task is completed” may be sent to the participant. notification information. That is, corresponding notification information may be sent in a targeted manner to different users.

In some embodiments, as shown in FIG. 2, the first task information 230 is displayed in a session interface 210 (e.g., of an instant messaging client) in a task card (which is also represented by a reference numeral “230”) having a preset style. The task card 230 is obtained based on task information and a preset information structure. In some embodiments, the task information may include, but is not limited to, creator information of the task, content information of the task, executor information of the task, time information of the task, state information of the task, attachment information of the task, department information of the task, and project information of the task. In some embodiments, the creator information of the task may include an initiator of the task, an assigner of the task, a leader of the task, and a creator of the task interface, etc. In some embodiments, the time information of the task may include creation time, modification time, and deadline time of the task. In some embodiments, the state information of the task may include task states such as “in progress” and “canceled”. In some embodiments, the department information may include a company department to which the task belongs. In some embodiments, the project information may include a project to which the task belongs. Accordingly, the task card may have corresponding fields arranged in a preset format, and the task information described above is arranged under the corresponding fields, respectively. The task information is displayed within the instant messaging session interface by means of the task card having the preset information structure, such that other users in a session may quickly be informed about related task information, thereby improving the efficiency of task information synchronization and processing.

In some embodiments, the information processing method of the present disclosure may further include: displaying task detail information associated with the task card in response to an operation on a second preset control in the first task information. As shown in FIG. 2, a second preset control 232 is schematically displayed in the first task information 230. It should be understood that the text “Task detail” in the second preset control 232 in FIG. 2 is only exemplary, and may also be other suitable text information. In some embodiments, when the first task information or the second preset control 232 in the task card 230 is triggered, task detail information associated with the task card 230 may be displayed. In some embodiments, the task detail information is displayed in a sidebar of a session interface 210 in which the task card 230 is located. In the embodiment, the task detail information is displayed in the sidebar of the session interface 210 such that a user can simultaneously browse the task detail information and context information of the task card 230 (session interface corresponding to the task card), thereby improving the information processing efficiency of the user.

Alternatively, apart from displaying the content displayed on the task card, the task detail information may further display attribute information and link information associated with an instant messaging session corresponding to the task card. The attribute information of the instant messaging session includes, but is not limited to, a name of the instant messaging session (e.g. a group name), a creator of the instant messaging session (e.g. a group owner), the number of members of the instant messaging session, creation time of the instant messaging session, a project to which the instant messaging session belongs, a department to which the instant messaging session belongs, etc. The link information of the instant messaging session is configured to be connected to a session page corresponding to the instant messaging session. Alternatively, in order to save the display space of task information in the instant messaging session, the task information may only display part of task content information; and the task detail information may display all of the task content information.

In some embodiments, the task detail information may further include information associated with the participant. For example, as shown in FIG. 3, exemplary task detail information 300 is shown, and “Follower” information associated with a participant may be displayed in the task detail information 300. For example, suppose a user X newly follows the first task information 230. At this point, after entering task detail information 300 of the first task information 230, information (e.g. a head portrait or a user name of the user X) of the user X as a follower or a participant may be displayed in a “Follower” item. In addition, it should be understood that the first task information 230 displayed on the instant messaging clients of other users is collaboratively changed to second task information including updated follower information. Thus, the efficiency of task online collaboration is improved, and other participants of the task may be informed about who is following the task in time.

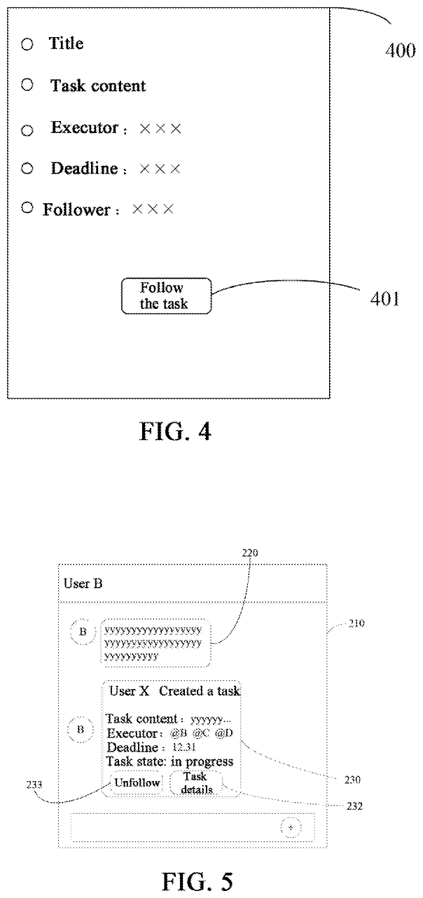

In some embodiments, displaying second task information in a task interface after a first preset control in the first task information is triggered includes: displaying task detail information associated with the first task information after the first preset control in the first task information is triggered; and display the second task information in the task interface after a third preset control in the task detail information is triggered. It should be understood that the first preset control in the embodiment may correspond to the second preset control 232 described above. After the first preset control is triggered, task detail information associated with the first task information may be displayed. For example, as shown in FIG. 4, exemplary task detail information 400 and a third preset control 401 in the task detail information 400 are shown. In some embodiments, the second task information is displayed in a task interface after the third preset control 401 in the task detail information 400 is triggered. Therefore, according to the embodiment of the present disclosure, the user can determine whether to become a participant of the task or whether to follow the task after entering an information detail page to view information details, thereby providing multiple possible ways of following for the user, avoiding tedious operations that the user returns to a display manner of the task card to follow the task after viewing task details, and improving user experience.

In some embodiments, displaying second task information in a task interface includes: displaying the second task information in a task interface that is different from a task interface displaying an executed or created task. For example, after the user follows the task, the second task information may be displayed in a “Followed by me” task interface instead of an “Executed by me” or a “Created by me” task interface. Thus, a more comprehensive and accurate classification is provided for the division of the task, and the user conveniently manages the task. The task interface or the display region for the participant is distinguished from the task interface or the display region for the executor or the creator such that related notification information can be sent to the follower in a more targeted manner, because a person who follows the progress of the task is usually a superior or a leader of the executor or the creator, not the executor of the task. The display region for the participant is distinguished from the display region for the executor or the creator, which is particularly suitable for a scene in which the superior and the leader obtain the notification message of the progress of the corresponding task in time.

In some embodiments, the participant is allowed to view the second task information, but is given no permission to modify an executor, a creator, a deadline, or a remark content in the second task information. In some embodiments, a participant of a certain task is allowed to view all related information of the task, but is not allowed to change information such as an executor, a creator, a deadline, or a remark content in the second task information. The participant is only allowed to select to “unfollow” the task, such that the participant in the task information of the task is changed, and is given no permission to delete other participants or add additional participants. In this way, confusion of task information changes is avoided, especially in the case of a large number of participants.

In some embodiments, after the first preset control in the first task information is triggered, a fourth preset control is displayed at the position at which the first preset control is displayed. With reference to FIGS. 2 and 5, after the first preset control 231 in the first task information 230 is triggered, that is, after a user follows the task, a fourth preset control 233 is displayed at the position at which the first preset control 231 is originally located such that the user can “unfollow” the task at any time. It should be understood that the text in the fourth preset control 233 is merely exemplary. In some embodiments, the information processing method of the present disclosure further includes: no longer displaying the second task information in the task interface after the fourth preset control 233 is triggered. That is, after the user “unfollows” the task, the second task information disappears from, for example, the “Followed by me” task interface and is no longer displayed. Thus, convenient operation approaches of “follow” and “unfollow” are provided for the user, thereby improving user experience.

In some embodiments, after the third preset control in the task detail information is triggered, a fifth preset control is displayed at the position at which the third preset control is displayed. With reference to FIGS. 4 and 3, after a third preset control 401 in the task detail information 400 is triggered, i.e., after a user follows the task, a fifth preset control 301 is displayed at the position at which the third preset control 401 is originally located such that the user can “unfollow” the task at any time. It should be understood that the text in the fifth preset control 301 is merely exemplary. In some embodiments, the information processing method of the present disclosure further includes: no longer displaying the second task information in the task interface after the fifth preset control 301 is triggered. That is, after the user “unfollows” the task, the second task information disappears from, for example, the “Followed by me” task interface and is no longer displayed. Thus, convenient operation approaches of “follow” and “unfollow” are provided for the user, thereby improving user experience.

In some embodiments, a task corresponding to the first task information includes a completed task. Even if the task has been completed, when subsequent work may refer to the previous task, details of the task may be informed by following the task. For example, when a later task is related or associated with a previously completed task, the situation of the completed task may be informed by following the completed task. Certainly, for the completed task, an instant messaging system may no longer send a related progress notification.

In some embodiments, displaying second task information in a task interface after a first preset control in the first task information is triggered includes: determining a content of a preset field of the second task information based on information of a user executing an operation on the first preset control, where the content of the preset field may include a content associated with the participant of the second task information. For example, in some embodiments, the participant or follower displayed in the first task information is user B, and after user X follows the task, the participant or follower in the second task information is changed to user B and user X. That is, user X is added. Accordingly, the content of the preset field (e.g. participant or follower) of the second task information is determined based on the user information of user X who executed a “follow” operation. As described above, the content associated with the participant may be information such as a user name or a head portrait of the participant.

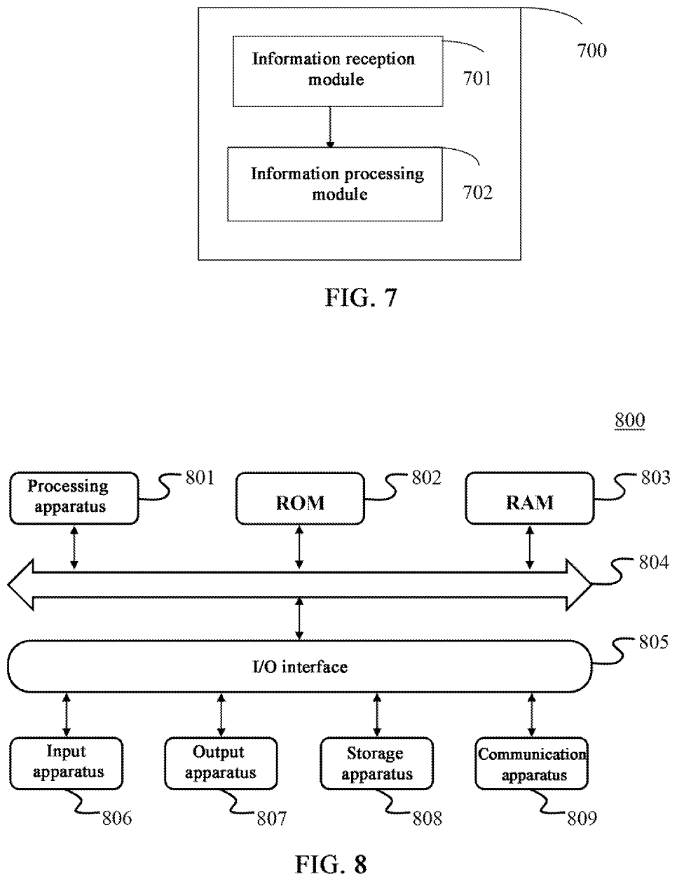

As shown in FIG. 7, an embodiment of the present disclosure also provides an information processing apparatus 700. The information processing apparatus 700 includes an information reception module 701 and an information processing module 702. In some embodiments, the information reception module 701 is configured to receive first task information. In some embodiments, the information processing module 702 is configured to display second task information in a task interface after a first preset control in the first task information is triggered, where participants of the first task information and the second task information are different, and display regions for the participants are different from display regions for executors or creators of corresponding task information.

It should be understood that the content described in relation to the information processing method is also suitable for the information processing apparatus 700 herein. For the sake of simplicity, no detailed description will be provided herein.

In some embodiments, receiving the first task information may include receiving the first task information at an instant messaging client, and displaying the second task information in the task interface may include displaying the second task information in the task interface of the instant messaging client. In some embodiments, the information processing module is further configured to: when information of a preset field of the second task information is changed, sending a first notification message to a participant of the second task information; and sending a second notification message to an executor of the second task information or without sending the first notification message to an executor of the second task information. In some embodiments, the information processing module is further configured to: when information of a preset field of the second task information is changed, sending a third notification message to an executor of second task information; and sending a fourth notification message to an executor of the second task information or without sending the third notification message to a follower of the second task information. In some embodiments, the preset field includes at least one of a title of a task, a content of the task, a deadline of the task, and a state of the task. In some embodiments, the first task information is displayed in a session interface of the instant messaging client in the form of a task card having a preset style. In some embodiments, the information processing module is further configured to display task detail information associated with the task card in response to an operation on a second preset control in the first task information. In some embodiments, the task detail information includes information associated with the participant.

In some embodiments, displaying second task information in a task interface after a first preset control in the first task information is triggered includes: displaying task detail information associated with the first task information after the first preset control in the first task information is triggered; and display the second task information in the task interface after a third preset control in the task detail information is triggered. In some embodiments, displaying second task information in a task interface includes: displaying the second task information in the task interface that is different from a task interface displaying an executed or created task. In some embodiments, the participant is allowed to view the second task information, but is given no permission to modify an executor, a creator, a deadline, or a remark content in the second task information. In some embodiments, after the first preset control in the first task information is triggered, a fourth preset control is displayed at a position at which the first preset control is displayed, and the information processing module is further configured to no longer display the second task information in the task interface after the fourth preset control is triggered. In some embodiments, after the third preset control in the task detail information is triggered, a fifth preset control is displayed at a position at which the third preset control is displayed, and the information processing module is further configured to no longer display the second task information in the task interface after the fifth preset control is triggered. In some embodiments, a task corresponding to the first task information includes a completed task. In some embodiments, displaying second task information in a task interface after a first preset control in the first task information is triggered includes: determining a content of a preset field of the second task information based on information of a user executing an operation on the first preset control, where the content of the preset field includes a content associated with the participant of the second task information.

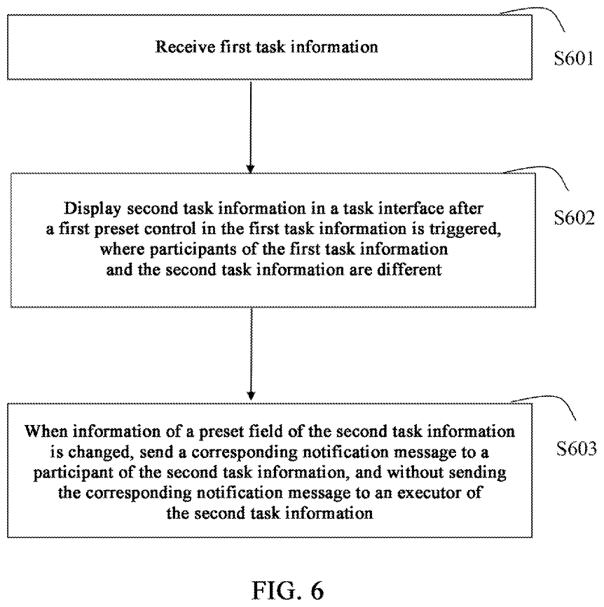

In some embodiments, as shown in FIG. 6, a flow chart of an information processing method is provided. The information processing method includes Step 601: receive first task information at an instant messaging client; and Step 602: display second task information in a task interface of the instant messaging client after a first preset control in the first task information is triggered, where participants of the first task information and the second task information are different. Steps 601-602 are basically similar to steps 101-102, except that display regions of the participants may be the same as or different from display regions for executors or creators. For the sake of simplicity, no detailed description will be provided herein. In addition, the information processing method may further include Step 603, when information of a preset field of the second task information is changed, send a corresponding notification message to a participant of the second task information, and without sending the corresponding notification message to an executor of the second task information. Corresponding explanations for Step 603 may be found in the above description, which will not be repeated herein.

In an embodiment, participant information of the first task information may be modified after a first preset control in the first task information is triggered, where the first task information includes a participant information set and an executor information set; and when information of a preset field of second task information is changed, a first notification message is sent to a participant of second task information according to the participant information set, and the first notification message is not sent to an executor of the second task information or a second notification message is sent to an executor of the second task information according to the executor information set.

In some embodiments, an information processing method is provided. The information processing method is basically the same as the method shown in FIG. 1. The only difference is that the task is not followed by other users, but other users are added as followers actively by the creator or executor of the task. Thus, an information processing method is provided that includes the following steps: receiving the first task information; in response to a preset operation by the executor or the creator of the first task information for adding a participant for the first task information, displaying second task information in a task interface, where participants of the first task information and the second task information are different. The same steps as in FIG. 1 will not be described in detail here, and only the differences will be briefly introduced below.

In some embodiments, the preset operation by the executor or the creator for adding the participant for the first task information may include any suitable operation that associates the task with another user. For example, associating the first task information with a certain user may include associating the first task information with a certain user through specified characters, such as @a certain user. In some embodiments, the first task information may include, for example, a preset control for adding a new user as a participant of the task. The creator or executor may associate the first task information with a corresponding user by triggering the control and selecting the corresponding user. Certainly, this is only illustrative, and other suitable ways may also be included to make the participants of the first task information and the second task information different.

The above mainly takes an instant messaging tool as an example to illustrate the information processing method. In some embodiments, an information processing method is provided, which can process task information in a document. In some embodiments, the document may be a local document, an online document, or another suitable document. It should be understood that, unless otherwise described or explicitly contradicted, the above information processing method regarding the application scene of the instant messaging tool is suitable for the information processing method in this embodiment, except that the application scene of this embodiment is for task information in the document.

In this embodiment, the information processing method includes: after a first preset control in first task information in a document interface is triggered, displaying second task information in the document interface, where participants of the first task information and the second task information are different, and the participants of the first task information and the second task information are different from executors or creators of corresponding task information. It should be understood that the participants of the task information are different from the executors or the creators of the corresponding task information as mentioned here means that the participants and executors, creators are of different identity attributes. The set of users who can be participants and the set of users who can be executors or creators can be the same or be different. For example, the same user may be both a participant and an executor or creator, may be only a participant, or only an executor or creator.

In some embodiments, as described above, the first task information may be displayed such as in the form of a card, and the first preset control may include, for example, a “Follow the task” control. After the first task information is followed by a new user, the first task information becomes the second task information due to the addition of the new participant (for example, a follower), such that the participants of the first task information and the second task information are different. In addition, a participant of the task information is usually different from the executor or creator of the task information. The creator is the user who creates the task information, the executor is the user who executes the task information, and the participant is the user who follows the task information. Certainly, in some embodiments, the executor or creator of the task information may also become a follower of the task information.

In some embodiments, the first preset control is only visible to the users other than the executor or the creator of the task information. In this way, the required controls can be presented to appropriate users in a targeted manner. Because the executor or the creator of a corresponding task can already see corresponding task information, sometimes it is no longer necessary to become a participant. By making the first preset control visible only to users other than the executor or the creator of the task information, the display space of the executor or the creator's task interface can be saved. In some embodiments, controls for viewing task details are visible only to executors, creators, and participants of the task information. In this way, the confidentiality of task information can be ensured. It should be understood that the information about the information processing method for the task information of the document that is not explicitly described here can be found in the above embodiments regarding the information processing method for the task information of the instant messaging tool, and will not be repeated here.

In addition, the present disclosure also provides an electronic device. The electronic device includes: at least one memory and at least one processor, where the memory is configured to store program codes, and the processor is configured to invoke the program codes stored in the at least one memory to execute the information processing method described above.

In addition, the present disclosure also provides a computer storage medium. The computer storage medium stores program codes, and the program codes are configured to execute the information processing method described above.

What is described above illustrates the information processing method and apparatus of the present disclosure on the basis of the embodiments and application examples. In addition, the present disclosure also provides a terminal and a storage medium, which are described below.

With reference to FIG. 8, a schematic structural diagram of an electronic device (such as a terminal device or a server) 800 suitable for implementing the embodiments of the present disclosure is shown below. The terminal device in the embodiments of the present disclosure may include, but is not limited to, mobile terminals such as mobile phones, laptops, digital broadcasting receivers, personal digital assistants (PDAs), portable android devices (PADs), portable multimedia players (PMPs) and car-mounted terminals (such as car-mounted navigation terminals), and fixed terminals such as digital televisions (TVs) and desktop computers. The electronic device shown in FIG. 8 is only an example and should not impose any limitation to the functions and scope of use of the embodiments of the present disclosure.

As shown in FIG. 8, the electronic device 800 may include a processing apparatus (such as a central processor and a graphics processor) 801 that may perform various suitable actions and processes according to programs stored in a read-only memory (ROM) 802 or programs loaded from a storage apparatus 808 into a random access memory (RAM) 803. Various programs and data necessary for the operation of the electronic device 800 are also stored in the RAM 803. The processing apparatus 801, the ROM 802, and the RAM 803 are connected to each other by a bus 804. An input/output (I/O) interface 805 is also connected to the bus 804.

Typically, the following apparatuses may be connected to the I/O interface 805: an input apparatus 806, including a touch screen, a touchpad, a keyboard, a mouse, a camera, a microphone, an accelerometer, or a gyroscope, for example; an output apparatus 807, including a liquid crystal display (LCD), a speaker, or a vibrator, for example; the storage apparatus 808, including a magnetic tape, or a hard drive, for example; and a communication apparatus 809, for example. The communication apparatus 809 may allow the electronic device 800 to perform wireless or wired communication with other devices to exchange data. Although FIG. 8 shows the electronic device 800 having various apparatuses, it should be understood that not all the apparatuses shown are required to be implemented or provided. More or less apparatuses may be alternatively implemented or provided.

Specifically, according to the embodiments of the present disclosure, the process described above with reference to the flow chart may be implemented as a computer software program. For example, an embodiment of the present disclosure includes a computer program product that includes a computer program carried on a computer-readable medium. The computer program includes program codes configured to execute the method shown in the flow chart. In such an embodiment, the computer program may be downloaded and mounted from the network by the communication apparatus 809, or mounted from the storage apparatus 808, or mounted from the ROM 802. The computer program, when executed by the processing apparatus 801, executes functions described above defined in the method of the embodiment of the present disclosure.

It should be noted that the computer-readable medium of the present disclosure may be a computer-readable signal medium, a computer-readable storage medium, or any combination of the computer-readable signal medium and the computer-readable storage medium. The computer-readable storage medium may be, for example, but not limited to, systems, apparatuses, or devices of electricity, magnetism, light, electromagnetism, infrared or semiconductors, or any combination of the above. More specific examples of the computer-readable storage medium may include, but is not limited to: an electrical connection having one or more wires, a portable computer disk, a hard drive, a RAM, a ROM, an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that includes or stores a program that may be used by an instruction execution system, an apparatus, or a device or in combination with the instruction execution system, the apparatus, or the device. In the present disclosure, the computer-readable signal medium may include data signals propagating in a baseband or as part of a carrier wave, which carries computer-readable program codes. The data signal propagating may take various forms, including, but not limited to, an electromagnetic signal, an optical signal, or any suitable combination of the above. The computer-readable signal medium may also be any computer-readable medium apart from the computer-readable storage medium, and the computer-readable signal medium may send, propagate, or transmit programs used by the instruction execution system, the apparatus, or the device or in combination with the instruction execution system, the apparatus, or the device. Program codes included on the computer-readable medium may be transmitted by using any suitable medium, including, but not limited to, wire, optical cable, radio frequency (RF), etc., or any suitable combination of the above.

In some embodiments, a client or a server may communicate by utilizing any currently known or future-developed network protocol such as hypertext transfer protocol (HTTP), and may interconnect with digital data communication (for example, a communication network) in any form or medium. Examples of a communication network include a local area network (“LAN”), a wide area network (“WAN”), an Internet work (for example, the Internet), an end-to-end network (for example, an ad hoc end-to-end network), as well as any currently known or future-developed network.

The computer-readable medium described above may be included in the electronic device described above, or exist separately without being assembled into the electronic device.

The computer-readable medium described above carries one or more programs, which, when executed by the electronic device, cause the electronic device to execute the method of the present disclosure described above.

Computer program codes configured to execute operations of the present disclosure may be written in one or more programming languages or a combination of the programming languages. The programming languages described above include object-oriented programming languages such as Java, Smalltalk, and C++, and also include conventional procedural programming languages such as “C” programming language or similar programming languages. The program codes may be executed entirely on a user computer, executed partially on the user computer, executed as a stand-alone software package, executed partially on the user computer and partially on a remote computer, or executed entirely on a remote computer or server. Where the remote computer is involved, the remote computer may be connected to the user computer by any kind of network, including the LAN or the WAN, or may be connected to an external computer (for example, connected via the Internet by an Internet service provider).

Flow charts and block diagrams in the accompanying drawings illustrate architecture, functions, and operations, which may be implemented according to systems, methods, and computer program products in the various embodiments of the present disclosure. In this regard, each block in flow diagrams or block diagrams may represent a module, a program segment, or a part of a code, which may include one or more executable instructions configured to implement specified logical functions. It should also be noted that in some alternative implementations, functions noted in the blocks may also occur in sequences different from those in the accompanying drawings. For example, the functions represented by two continuous blocks may be actually performed basically in parallel, and sometimes performed in reverse sequences, which depends on the involved functions. It should also be noted that each block in the block diagrams and/or the flow diagrams, and combinations of the blocks in the flow diagrams and/or the block diagrams may be implemented by using dedicated hardware-based systems that perform the specified functions or operations, or may be implemented by using combinations of dedicated hardware and computer instructions.

The units described in the embodiment of the present disclosure may be implemented by software or hardware. The names of the units do not constitute limitations to the units themselves.

The functions described above herein may be at least partially executed by one or more hardware logic components. For example, non-restrictively, demonstration types of hardware logic components that may be used include: a field programmable gate array (FPGA), an application-specific integrated circuit (ASIC), an application-specific standard product (ASSP), a system on chip (SOC), a complex programmable logic device (CPLD), etc.

In the context of the present disclosure, a machine-readable medium may be a tangible medium that may include or store a program for use by an instruction execution system, an apparatus, or a device or in combination with the instruction execution system, the apparatus, or the device. The computer-readable medium may be a computer-readable signal medium or a computer-readable storage medium. The machine-readable medium may include, but not limited to, an electronic, magnetic, optical, electromagnetic, infrared, or semiconductor system, apparatus, or device, or any suitable combination of the above. More specific embodiments of the machine-readable storage medium may include an electrical connection based on one or more wires, a portable computer diskette, a hard disk, a RAM, a ROM, an EPROM (or flash memory), an optical fiber, a portable CD-ROM, an optical storage device, a magnetic storage device, or any suitable combination of the above.

According to one or more embodiments of the present disclosure, an information processing method is provided. The information processing method comprises: receiving first task information; and displaying second task information in a task interface after a first preset control in the first task information is triggered, where participants of the first task information and the second task information are different, and display regions for the participants are different from display regions for executors or creators of corresponding task information.

According to one or more embodiments of the present disclosure, receiving the first task information comprises receiving the first task information at an instant messaging client, and displaying the second task information in the task interface comprises displaying the second task information in the task interface of the instant messaging client.

According to one or more embodiments of the present disclosure, the information processing method further comprises: when information of a preset field of the second task information is changed, sending a first notification message to a participant of the second task information; and without sending the first notification message to an executor of the second task information, or sending a second notification message to an executor of the second task information.

According to one or more embodiments of the present disclosure, the information processing method further comprises: when information of a preset field of the second task information is changed, sending a third notification message to an executor of the second task information; and without sending the third notification message to a participant of the second task information, or sending a fourth notification message to a participant of the second task information.

According to one or more embodiments of the present disclosure, the preset field includes at least one of a title of a task, a content of the task, a deadline of the task, a participant of the task, an executor of the task, and a state of the task.

According to one or more embodiments of the present disclosure, the first task information is displayed in a session interface of the instant messaging client in the form of a task card having a preset style.

According to one or more embodiments of the present disclosure, the information processing method further comprises: displaying task detail information associated with the task card in response to an operation on a second preset control in the first task information.

According to one or more embodiments of the present disclosure, the task detail information includes information associated with the participant.

According to one or more embodiments of the present disclosure, displaying second task information in a task interface after a first preset control in the first task information is triggered comprises: displaying task detail information associated with the first task information after the first preset control in the first task information is triggered; and display the second task information in the task interface after a third preset control in the task detail information is triggered.

According to one or more embodiments of the present disclosure, displaying second task information in a task interface comprises: displaying the second task information in a task interface that is different from a task interface displaying an executed or created task.

According to one or more embodiments of the present disclosure, the participant is allowed to view the second task information, but is given no permission to modify an executor, a creator, a deadline, or a remark content in the second task information.

According to one or more embodiments of the present disclosure, after the first preset control in the first task information is triggered, a fourth preset control is displayed at a position at which the first preset control is displayed, and the method further includes: no longer displaying the second task information in the task interface after the fourth preset control is triggered.

According to one or more embodiments of the present disclosure, after the third preset control in the task detail information is triggered, a fifth preset control is displayed at a position at which the third preset control is displayed, and the method further includes: no longer displaying the second task information in the task interface after the fifth preset control is triggered.

According to one or more embodiments of the present disclosure, a task corresponding to the first task information includes a completed task.

According to one or more embodiments of the present disclosure, displaying second task information in a task interface after a first preset control in the first task information is triggered comprises: determining a content of a preset field of the second task information based on information of a user executing an operation on the first preset control, where the content of the preset field includes a content associated with a participant of the second task information.

According to one or more embodiments of the present disclosure, an information processing method is provided. The information processing method comprises: receiving first task information; modifying participant information of the first task information after a first preset control in the first task information is triggered, where the first task information includes a participant information set and an executor information set; and when information of a preset field of the second task information is changed, sending a first notification message to a participant of the second task information according to the participant information set.

According to one or more embodiments of the present disclosure, the information processing method further comprises: according to the executor information set, avoiding sending the first notification message to an executor of the second task information or sending a second notification message to an executor of the second task information.

According to one or more embodiments of the present disclosure, an information processing apparatus is provided. The information processing apparatus comprises: an information reception module configured to receive first task information; and an information processing module configured to display second task information in a task interface after a first preset control in the first task information is triggered, where participants of the first task information and the second task information are different, and display regions for the participants are different from display regions for executors or creators of corresponding task information.

According to one or more embodiments of the present disclosure, an information processing method is provided. The information processing method comprises: receiving first task information; and in response to a preset operation by an executor or a creator of the first task information for adding a participant for the first task information, displaying second task information in a task interface, where participants of the first task information and the second task information are different.

According to one or more embodiments of the present disclosure, an information processing method is provided. The information processing method comprises: after a first preset control in first task information in a document interface is triggered, displaying second task information in the document interface, where participants of the first task information and the second task information are different, and the participants of the first task information and the second task information are different from executors or creators of corresponding task information.

According to one or more embodiments of the present disclosure, an electronic device is provided. The electronic device includes: at least one memory and at least one processor, where the at least one memory is configured to store program codes, and the at least one processor is configured to invoke the program codes stored in the at least one memory to execute the method of any one as described above.

According to one or more embodiments of the present disclosure, a storage medium is provided. The storage medium is configured to store program codes, where the program codes are configured to execute the method described above.

What is described above is only for illustration of the preferred embodiments of the present disclosure and the technical principles used. It should be understood by those skilled in the art that the disclosed scope involved in the present disclosure is not limited to the technical solution formed by a specific combination of the technical features described above, and should also cover other technical solutions formed by any combination of the technical features described above or equivalent features without departing from the disclosed concept described above. For example, the technical solution formed by replacing the features described above with the technical features having similar functions disclosed in (but not limited to) the present disclosure or vice versa.

Furthermore, although each operation is described in a specific order, this should not be understood as requiring the operations to be executed in the specific order shown or in a sequential order. In certain environments, multitasking and parallel processing may be advantageous. Similarly, although several specific implementation details are included in the above discussion, these details should not be interpreted as limiting the scope of the present disclosure. Some features described in the context of the separate embodiments can also be combined and implemented in a single embodiment. On the contrary, various features described in the context of a single embodiment can also be implemented in multiple embodiments separately or in any suitable sub-combination manner.

Although the subject matter has been described in language specific to structural features and/or method logical actions, it should be understood that the subject matter defined in the appended claims may not necessarily be limited to the specific features or actions described above. On the contrary, the specific features and actions described above are only exemplary forms for implementing the claims.

I/We claim:

1. An information processing method, comprising:
receiving first task information; and
displaying second task information in a task interface after a first preset control in the first task information is triggered, wherein participants of the first task information and the second task information are different, and display regions for the participants are different from display regions for executors or creators of corresponding task information.

2. The information processing method according to claim 1, wherein receiving first task information comprises receiving the first task information at an instant messaging client, and displaying second task information in a task interface comprises displaying the second task information in a task interface of the instant messaging client.

3. The information processing method according to claim 1, further comprising:
when information of a preset field of the second task information is changed, sending a first notification message to a participant of the second task information, and sending a second notification message to an executor of the second task information or without sending the first notification message to an executor of the second task information.

4. The information processing method according to claim 1, further comprising:
when information of a preset field of the second task information is changed, sending a third notification message to an executor of the second task information, and sending a fourth notification message to a participant of the second task information or without sending the third notification message to a participant of the second task information.

5. The information processing method according to claim 3, wherein the preset field includes at least one of a title of a task, a content of the task, a deadline of the task, a participant of the task, an executor of the task, and a state of the task.

6. The information processing method according to claim 2, wherein the first task information is displayed in a session interface of the instant messaging client in the form of a task card having a preset style.

7. The information processing method according to claim 6, further comprising: displaying task detail information associated with the task card in response to an operation on a second preset control in the first task information.

8. The information processing method according to claim 4, wherein the task detail information includes information associated with the participant.

9. The information processing method according to claim 1, wherein the displaying second task information in a task interface of the instant messaging client after a first preset control in the first task information is triggered comprises:
displaying task detail information associated with the first task information after the first preset control in the first task information is triggered; and
displaying the second task information in the task interface of the instant messaging client after a third preset control in the task detail information is triggered.

10. The information processing method according to claim 1, wherein the displaying the second task information in a task interface comprises: displaying the second task information in a task interface that is different from a task interface displaying an executed or created task.

11. The information processing method according to claim 1, wherein a task interface is configured to allow a participant to view the second task information, but give no permission to a participant to modify an executor, a creator, a deadline, or a remark content in the second task information.

12. The information processing method according to claim 1, wherein after the first preset control in the first task information is triggered, a fourth preset control is displayed at a position at which the first preset control is displayed, and the method further comprises:
no longer displaying the second task information in the task interface after the fourth preset control is triggered.

13. The information processing method according to claim 6, wherein after the third preset control in the task detail information is triggered, a fifth preset control is displayed at a position at which the third preset control is displayed, and the method further comprises:
no longer displaying the second task information in the task interface after the fifth preset control is triggered.

14. The information processing method according to claim 1, wherein a task corresponding to the first task information comprises a completed task.

15. The information processing method according to claim 1, wherein the displaying the second task information in a task interface after the first preset control in the first task information is triggered comprises:
determining a content of a preset field of the second task information based on information of a user executing an operation on the first preset control, wherein the content of the preset field includes a content associated with a participant of the second task information.

16. An information processing method, comprising:
receiving first task information;
modifying participant information of the first task information after a first preset control in the first task information is triggered, where the first task information includes a participant information set and an executor information set; and
when information of a preset field of the second task information is changed, sending a first notification message to a participant of the second task information according to the participant information set.

17. The information processing method according to claim 16, further comprising:
according to the executor information set, avoiding sending the first notification message to an executor of the second task information, or sending a second notification message to an executor of the second task information.

18. An information processing method, comprising:
receiving first task information;
in response to a preset operation by an executor or a creator of the first task information for adding a participant for the first task information, displaying second task information in a task interface, where participants of the first task information and the second task information are different.

19. The information processing method according to claim 18, wherein receiving first task information comprises receiving the first task information at an instant messaging client, and displaying second task information in a task interface comprises displaying the second task information in a task interface of the instant messaging client.

20. An information processing method, comprising:
after a first preset control in first task information in a document interface is triggered, displaying second task information in the document interface, where participants of the first task information and the second task information are different, and the participants of the first task information and the second task information are different from executors or creators of corresponding task information.
